(19) United States
(12) Patent Application Publication
(10) Pub. No.: US 2020/0249468 A1
(43) Pub. Date: Aug. 6, 2020

(54) MICROMIRROR STRUCTURE AND MICROMIRROR ARRAY CHIP

(71) Applicant: HUAWEI TECHNOLOGIES CO., LTD., Shenzhen (CN)

(72) Inventor: Danyang YAO, Shenzhen (CN)

(73) Assignee: HUAWEI TECHNOLOGIES CO., LTD., Shenzhen (CN)

(21) Appl. No.: 16/855,051

(22) Filed: Apr. 22, 2020

Related U.S. Application Data
(63) Continuation of application No. PCT/CN2018/102703, filed on Aug. 28, 2018.

(30) Foreign Application Priority Data
Oct. 27, 2017 (CN) 201711033201.1

(51) Int. Cl. G02B 26/08; G09G 3/34

(52) U.S. Cl. CPC G02B 26/0866; G09G 3/346

(57) ABSTRACT

A micromirror structure includes an outer frame, an inner frame, a lens, a pair of first hinges, a pair of second hinges, a first driver module, and a second driver module. The pair of first hinges is respectively connected between two ends of the lens and an inner wall of the inner frame, and a connection line of the pair of first hinges forms a first rotation axis. The pair of second hinges is respectively connected between an outer wall of the inner frame and an inner wall of the outer frame, a connection line of the pair of second hinges forms a second rotation axis, and the first rotation axis is perpendicular to the second rotation axis. The micromirror structure can ensure that the lens is precisely positioned in a rotation process.

### CROSS-REFERENCE TO RELATED APPLICATIONS

This application is a continuation of International Application No. PCT/CN2018/102703, filed on Aug. 28, 2018, which claims priority to Chinese Patent Application No. 201711033201.1, filed on Oct. 27, 2017. The disclosures of the aforementioned applications are hereby incorporated by reference in their entireties.

### TECHNICAL FIELD

Embodiments relate to a micromirror driving technology, and in particular, to a micromirror structure and a micromirror array chip.

### BACKGROUND

A thermoelectric MEMS (micro-electro-mechanical system) driving technology may operate by generating driving force through thermal deformation of a material. Compared with other MEMS driving technologies, the thermoelectric MEMS driving technology has advantages including a strong driving force, a large displacement, and the like, and has very broad application prospects. Especially in the optical communications field, a thermoelectric MEMS micromirror is manufactured in an array form by using the thermoelectric driving technology, two MEMS micromirror array chips are used to form an optical path, and when an MEMS micromirror on a driving array deflects to a proper position, an OXC (optical cross-connect) function of switching communication light from an input port to any output port may be implemented. Because the thermoelectric MEMS micromirror has an advantage of a large deflection angle, this may support the assembling of an OXC module having a large port. In this way, a switching capacity of the OXC module is greatly expanded, to meet communication data transmission requirements that grow at a high speed.

How to design a micromirror structure that can ensure a more precise position of a micromirror in a deflection process is a direction of continuous research in the industry.

### SUMMARY

Embodiments provide a micromirror structure, to ensure that a more precise position of a lens is obtained when the lens deflects. The embodiments contemplated herein further provide a micromirror array chip including the micromirror structure.

According to a first aspect, an embodiment provides a micromirror structure, including an outer frame, an inner frame, a lens, a pair of first hinges, a pair of second hinges, a first driver module, and a second driver module. In this embodiment, the lens is an MEMS micromirror. The pair of first hinges is respectively located at two opposite ends of the lens, the pair of first hinges is connected between the lens and an inner wall of the inner frame, and a connection line of the pair of first hinges forms a first rotation axis. The pair of second hinges is respectively located at two opposite ends of the inner frame, the pair of second hinges is connected between an outer wall of the inner frame and an inner wall of the outer frame, a connection line of the pair of second hinges forms a second rotation axis, and the first rotation axis is perpendicular to the second rotation axis. The first driver module is connected to the inner frame, and is positioned to drive the inner frame, together with the lens, to rotate by using the second rotation axis as a center. The second driver module is connected to the lens, and is positioned to drive the lens to rotate by using the first rotation axis as a center. In this embodiment, the inner frame is disposed between the lens and the outer frame, the pair of first hinges is connected between the inner frame and the lens to form the first rotation axis, the pair of second hinges is connected between the inner frame and the outer frame to from the second rotation axis, and the first rotation axis is perpendicular to the second rotation axis, so that the lens cannot displace in a direction perpendicular to the lens because the lens is constrained by the pair of first hinges when the lens rotates around the first rotation axis, and the lens cannot displace in a direction perpendicular to the lens because the lens is constrained by the pair of second hinges when the lens rotates around the second rotation axis. This can ensure a more precise position of the lens in a deflection process. In addition, a structure used by the lens to rotate around the first rotation axis and a structure used by the lens to rotate around the second rotation axis are independent of each other. Therefore, there is no mechanical crosstalk between deflection around the first rotation axis and deflection around the second rotation axis.

In an implementation, the pair of first hinges implements a rigid connection between the lens and the inner frame in a direction of the first rotation axis, so that no displacement occurs between the inner frame and the lens when the first driver module drives the inner frame, together with the lens, to rotate by using the second rotation axis as a center, thereby ensuring precise positioning of the lens. In addition, the pair of first hinges implements the rigid connection between the lens and the inner frame in the direction of the first rotation axis, so that fixedness of a position of the first rotation axis can be determined. If the first hinges are flexibly connected between the lens and the inner frame in the direction of the first rotation axis, when the second driver module drives the lens to rotate by using the first rotation axis as a center, the position of the first rotation axis will change very easily due to elastic deformation of the first hinges (the position change may be referred to as an unwanted offset, and a direction and a displacement of the position change are uncertain). Consequently, the lens is imprecisely positioned.

In an implementation, the pair of second hinges implements a rigid connection between the inner frame and the outer frame in a direction of the second rotation axis, so that fixedness of a position of the second rotation axis can be determined, so that the lens is precisely positioned when the lens rotates around the second rotation axis.

In a process in which the lens rotates by using the first rotation axis as a center, a deflection position of the lens is maintained through elastic deformation of the pair of first hinges. In other words, in a rotation direction of the first hinges, the first hinges are flexibly connected between the inner frame and the lens.

In a process in which the inner frame, together with the lens, rotates by using the second rotation axis as a center, a deflection position of the inner frame together with the lens is maintained through elastic deformation of the pair of second hinges. In other words, in a rotation direction of the second hinges, the second hinges are flexibly connected between the inner frame and the outer frame.

In an implementation, the first driver module includes a first thermoelectric driving arm, the first thermoelectric driving arm is connected between the outer frame and the inner frame, an end of the first thermoelectric driving arm and that is connected to the inner frame may be designated as a first connection end, and a center of the first connection end is located on the first rotation axis. In this embodiment, the first driver module is designed as a thermoelectric driving arm. When the first thermoelectric driving arm is heated, the first thermoelectric driving arm deforms, so that the first connection end displaces in the direction perpendicular to the lens. The first rotation axis is set to a direction X, the second rotation axis is set to a direction Y, and the direction perpendicular to the lens is a direction Z. In this implementation, the first connection end of the first thermoelectric driving arm is moved in the direction Z, to drive the inner frame, together with the lens, to rotate by using the second rotation axis as a center.

In an implementation, there is one first connection end, and the first connection end is located on the first rotation axis. The first thermoelectric driving arm may include a first electrode end, a first elastic arm, and the first connection end, the first electrode end and the first connection end are respectively located on two sides of the first elastic arm, the first electrode end is configured to be electrically connected to a first electrode, to apply a voltage or a current to the first thermoelectric driving arm. Under the action of a voltage difference and a current, the first elastic arm thermally deforms, to drive the first connection end to move in the direction Z. In this implementation, the first elastic arm is in a packaged ring-shaped structure.

In an implementation, there are at least two first connection ends, and the at least two first connection ends are symmetrically distributed by using the first rotation axis as a center, so that a center of the first connection ends is located on the first rotation axis. This is beneficial for the first thermoelectric driving arm to apply uniform force to the inner frame. In this implementation, the first thermoelectric driving arm includes a first electrode end, two first elastic arms, and two first connection ends, whereby the ends of the two first elastic arms are respectively connected to the two first connection ends, and the other ends of the two first elastic arms are both connected to the first electrode end.

In an implementation, the first driver module further includes the first electrode, the first electrode is disposed on the outer frame, and the first electrode is electrically connected to the first thermoelectric driving arm. In the implementation, the first electrode is electrically connected to the first electrode end, the outer frame may be designed as a circuit board, and the first electrode is electrically connected to the first electrode end by using cables on the circuit board.

A center of the first electrode end may be located on an extension line of the first rotation axis.

The second driver module includes a second thermoelectric driving arm, the second thermoelectric driving arm is connected between the inner frame and the lens, an end of the second thermoelectric driving arm that is connected to the inner frame may be designated as a second electrode end, and a center of the second electrode end is located on an extension line of the second rotation axis. An architecture of the second driver module may be the same as that of the first driver module, though, in an implementation, the positions each are disposed in may be different. The second driver module is disposed between the inner frame and the lens. In the implementation, the second thermoelectric driving arm includes the second electrode end, a second connection end, and a second elastic arm connected between the second electrode end and the second connection end, whereby the second electrode end is connected to the inner frame.

In an implementation, the second driver module further includes a second electrode, the second electrode is disposed on the outer frame, and the second electrode is electrically connected to the second thermoelectric driving arm. In the implementation, the second electrode is electrically connected to the second electrode end.

In an implementation, the second electrode end and one of the second hinges are respectively disposed on two sides of the inner frame oppositely, that is, the second electrode end is located on an extension line of the second hinge. In other words, the second hinge is located on the second rotation axis. The second electrode is electrically connected to the second thermoelectric driving arm by using leads, whereby the leads extend from the outer frame to one of the second hinges, and extend to the second thermoelectric driving arm along the second hinge.

An end of the second thermoelectric driving arm that is connected to the lens may be the second connection end, and a center of the second connection end is located on the second rotation axis.

There are at least two second connection ends, and the at least two second connection ends are symmetrically distributed by using the second rotation axis as a center, so that a center of the second connection ends is located on the second rotation axis. In this way, the second driver module can apply uniform force to the lens.

In an implementation, the first electrode end is connected to a surface of the outer frame, and the first connection end is connected to a surface of the inner frame. Because a thermoelectric driving arm is additionally made on a surface of a silicon material (the inner frame and a surface of the lens belong to a base structure) by using a semiconductor technology, the first connection end is located on the surface of the inner frame. Likewise, the second electrode end is connected to a surface of the inner frame, and the second connection end is connected to a surface of the lens.

In an implementation, the inner frame is of an axisymmetrical structure, and both the first rotation axis and the second rotation axis form symmetry axes of the inner frame. The inner frame may be of any axisymmetrical structure, for example, in a square frame shape or in a circular ring shape.

According to a second aspect, an embodiment provides a micromirror array chip, including a plurality of micromirror structures, distributed in arrays, according to any one of the foregoing implementations.

The micromirror array chip is divided into a plurality of areas distributed in arrays, the plurality of areas distributed in arrays include a first area and a second area that are disposed adjacent to each other, a distribution direction of the micromirror structure in the first area is mirror-symmetric to a distribution direction of the micromirror structure in the second area.

### BRIEF DESCRIPTION OF DRAWINGS

FIG. 1 is a schematic structural diagram of a 3D-MEMS optical switching module on which a micromirror array chip is located according to an implementation;

FIG. 2 is a schematic diagram of a micromirror structure according to an implementation;

FIG. 3 is a schematic diagram of a micromirror structure according to another implementation;

FIG. 4 is a schematic diagram of a micromirror array chip layout manner according to an implementation; and

FIG. 5 is a diagram of a relationship between a deflection angle and power consumption of a micromirror array chip according to an implementation.

### DESCRIPTION OF EMBODIMENTS

The following describes numerous embodiments with reference to the accompanying drawings depicting said embodiments.

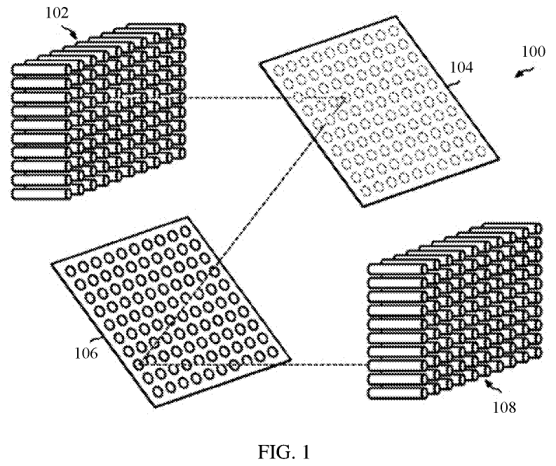

An embodiment relates to a micromirror structure and a micromirror array chip that are core devices in the optical switching field. FIG. 1 is a schematic structural diagram of a 3D-MEMS optical switching module (namely, an MEMS photonic switch 100) on which a micromirror array chip is located according to this embodiment. The MEMS photonic switch 100 includes a first lens array 104 and a second lens array 106. Light enters through a collimator array 102 (for example, light is led from an optical fiber), and is projected on a micromirror in the first lens array 104. An angle of the micromirror in the first lens array 104 is adjusted, to enable the light to be further projected on a proper micromirror in the second lens array 106. The micromirror in the second lens array 106 is associated with a specific output port in a collimator array 108. An angle of the micromirror in the lens array 106 is adjusted, to enable the micromirror in the lens array 106 to be coupled to a proper output port in the collimator array 108. Then, the light is emitted from a collimator in the collimator array 108 (for example, coupled to an optical fiber). Similarly, light may be input from one side of the collimator array 108, reflected from a micromirror in the second lens array 106 to a micromirror in the first lens array 104, further reflected to the collimator array 102, and emitted. The micromirror structure and the micromirror array chip that are provided in the embodiments contemplated herein may be applied to the first lens array 104 or the second lens array 106.

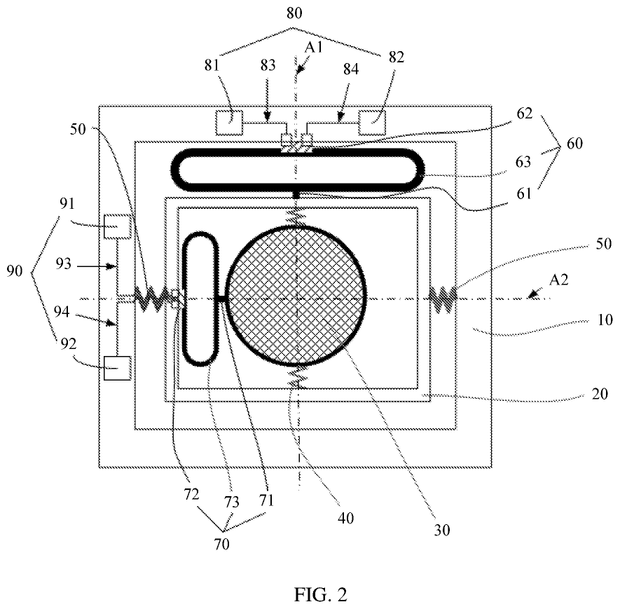

Referring to FIG. 2, a micromirror structure provided in an embodiment includes an outer frame 10, an inner frame 20, a lens 30, a pair of first hinges 40, a pair of second hinges 50, a first driver module, and a second driver module. The lens 30 is located in enclosed space of the inner frame 20, and the inner frame 20 is located in enclosed space of the outer frame 10. The lens 30, the inner frame 20, and the outer frame 10 form a layer-by-layer nesting architecture, and a gap is maintained between the lens 30, the inner frame 20, and the outer frame 10, to accommodate the first hinges 40, the second hinges 50, the first driver module, and the second driver module. In an implementation, the outer frame 10 may be formed by digging a hole on a base board, and a material of the outer frame 10 may be a silicon material. The enclosed space of the outer frame 10 may be rectangular. A plurality of accommodation holes distributed in arrays may be disposed on one base board. These accommodation holes are used as the enclosed space of the outer frame 10. The inner frame 20, the lens 30, the first hinges 40, the second hinges 50, the first driver module, and the second driver module are disposed in the accommodation holes.

The inner frame 20 is of an enclosed ring-shaped structure, and may be of an axisymmetrical structure, for example, in a rectangular shape or a circular shape (it may be understood that a shape of the inner frame 20 may be any other shape and is not limited in this application). A material of the inner frame 20 may be the same as the material of the outer frame 10, and the inner frame 20 is of a rigid structure.

The pair of first hinges 40 is respectively located at two opposite ends of the lens 30, the pair of first hinges 40 is connected between the lens 30 and an inner wall of the inner frame 20, and a connection line of the pair of first hinges 40 forms a first rotation axis A1. The first hinges 40 are of a structure similar to a rotation axis or hinge, and can implement rotation of the lens 30 relative to the inner frame 20. In a direction other than a rotation direction, the first hinges 40 can ensure a rigid connection between the lens 30 and the inner frame 20, to prevent the lens 30 from offsetting relative to the inner frame 20, thereby ensuring deflection precision of the lens 30.

The pair of second hinges 50 is respectively located at two opposite ends of the inner frame 20, the pair of second hinges 50 is connected between an outer wall of the inner frame 20 and an inner wall of the outer frame 10, a connection line of the pair of second hinges 50 forms a second rotation axis A2, and the first rotation axis A1 is perpendicular to the second rotation axis A2. The second hinges 50 are of a structure similar to a rotation axis or hinge, and can implement rotation of the inner frame 20 relative to the outer frame 10. In a direction other than a rotation direction, the second hinges 50 can ensure a rigid connection between the inner frame 20 and the outer frame 10, to prevent the inner frame 20 from offsetting relative to the outer frame 10, thereby ensuring deflection precision of the lens 30.

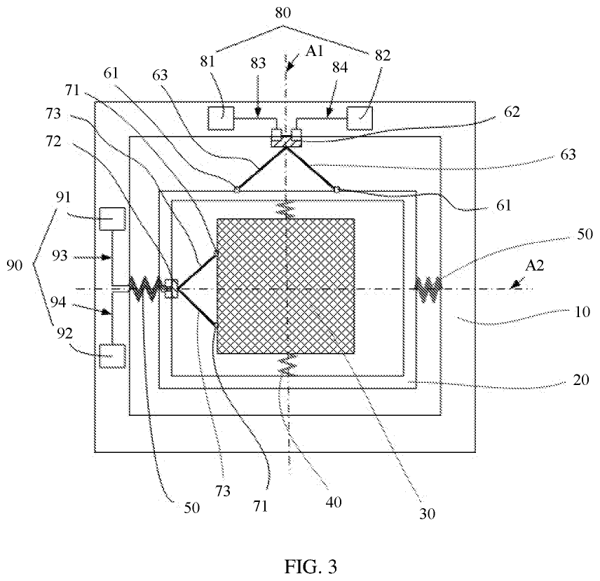

In an implementation, the inner frame 20 is of an axisymmetrical structure, and both the first rotation axis A1 and the second rotation axis A2 form symmetry axes of the inner frame 20. The inner frame 20 may be of any axisymmetrical structure, for example, in a square frame shape or in a circular ring shape. In embodiments shown in FIG. 2 and FIG. 3, the inner frame 20 is in a rectangular frame shape, and includes four sides perpendicular to each other, and the first rotation axis A1 and the second rotation axis A2 each are a midline of two adjacent sides.

In an implementation, the lens 30 is an MEMS micromirror, and the lens 30 is circular. In another implementation, the lens 30 may be rectangular. When the lens 30 is circular, the first rotation axis A1 coincides with a diameter of the lens 30. When the lens 30 is square, the first rotation axis A1 coincides with a midline of the lens 30. It should be understood that the lens 30 may be in any shape. This is not limited by the embodiments provided herein.

The first driver module is connected to the inner frame 20, to drive the inner frame 20, together with the lens 30, to rotate by using the second rotation axis A2 as a center. The second driver module is connected to the lens 30, to drive the lens 30 to rotate by using the first rotation axis A1 as a center. In this embodiment, the inner frame 20 is disposed between the lens 30 and the outer frame 10, the pair of first hinges 40 is connected between the inner frame 20 and the lens 30 to form the first rotation axis A1, the pair of second hinges 50 is connected between the inner frame 20 and the outer frame 10 to from the second rotation axis A2, and the first rotation axis A1 is perpendicular to the second rotation axis A2, so that the lens 30 cannot displace in a direction perpendicular to the lens 30 because the lens 30 is constrained by the pair of first hinges 40 when the lens 30 rotates around the first rotation axis A1, and the lens 30 cannot displace in the direction perpendicular to the lens 30 because the lens 30 is constrained by the pair of second hinges 50 when the lens 30 rotates around the second rotation axis A2. This can ensure that the lens 30 is more precisely positioned in a deflection process.

In an implementation, the pair of first hinges 40 implements a rigid connection between the lens 30 and the inner frame 20 in a direction of the first rotation axis A1, so that no displacement occurs between the inner frame 20 and the lens 30 when the first driver module drives the inner frame 20, together with the lens 30, to rotate by using the second rotation axis A2 as a center, thereby ensuring a precise position of the lens 30. In addition, the pair of first hinges 40 implements the rigid connection between the lens 30 and the inner frame 20 in the direction of the first rotation axis A1, so that fixedness of a position of the first rotation axis A1 can be determined. If the first hinges 40 are flexibly connected between the lens 30 and the inner frame 20 in the direction of the first rotation axis A1, when the second driver module drives the lens 30 to rotate by using the first rotation axis A1 as a center, the position of the first rotation axis A1 very easily changes due to elastic deformation of the first hinges 40. (As noted, this position change may be an unwanted offset, and a direction and a displacement of the position change are uncertain.) Consequently, the lens 30 is imprecisely positioned.

In an implementation, the pair of second hinges 50 implements a rigid connection between the inner frame 20 and the outer frame 10 in a direction of the second rotation axis A2, in order that fixedness of a position of the second rotation axis A2 can be determined, so that the lens 30 is precisely positioned when the lens 30 rotates around the second rotation axis A2.

In a process in which the lens 30 rotates by using the first rotation axis A1 as a center, a deflection position of the lens 30 is maintained through elastic deformation of the pair of first hinges 40. In other words, in a rotation direction of the first hinges 40, the first hinges 40 are flexibly connected between the inner frame 20 and the lens 30.

In a process in which the inner frame 20, together with the lens 30, rotates by using the second rotation axis A2 as a center, a deflection position of the inner frame 20 together with the lens 30 is maintained through elastic deformation of the pair of second hinges 50. In other words, in a rotation direction of the second hinges 50, the second hinges 50 are flexibly connected between the inner frame 20 and the outer frame 10.

The first driver module and the second driver module are configured to drive the lens 30 to deflect. In this embodiment, the lens 30 is driven to deflect in a thermoelectric driving manner. Specific descriptions are as follows:

In an implementation, the first driver module includes a first thermoelectric driving arm 60, the first thermoelectric driving arm 60 is connected between the outer frame 10 and the inner frame 20, an end of the first thermoelectric driving arm 60 that is connected to the inner frame 20 may be a first connection end 61, and a center of the first connection end 61 is located on the first rotation axis A1. In this embodiment, the first driver module is designed as a thermoelectric driving arm. When the first thermoelectric driving arm 60 is heated, the first thermoelectric driving arm 60 deforms, so that the first connection end 61 displaces in the direction perpendicular to the lens 30. The first rotation axis A1 is set to a direction X, the second rotation axis A2 is set to a direction Y, and the direction perpendicular to the lens 30 is a direction Z. In this implementation, the first connection end 61 of the first thermoelectric driving arm 60 is moved in the direction Z, to drive the inner frame 20, together with the lens 30, to rotate by using the second rotation axis A2 as a center.

In an implementation, as shown in FIG. 2, there is one first connection end 61, and the first connection end 61 is located on the first rotation axis A1. In the implementation, the first thermoelectric driving arm 60 includes a first electrode end 62, a first elastic arm 63, and the first connection end 61, the first electrode end 62 and the first connection end 61 are respectively located on two sides of the first elastic arm 63, the first electrode end 62 is configured to be electrically connected to a first electrode 80 disposed on the outer frame 10, to apply a voltage or a current to the first thermoelectric driving arm 60. Under the action of a voltage difference and a current, the first elastic arm 63 thermally deforms, to drive the first connection end 61 to move in the direction Z. In this implementation, the first elastic arm 63 is in a packaged ring-shaped structure.

In an implementation, as shown in FIG. 3, there are at least two first connection ends 61, and the at least two first connection ends 61 are symmetrically distributed by using the first rotation axis A1 as a center, so that a center of the first connection ends 61 is located on the first rotation axis A1. This is beneficial for the first thermoelectric driving arm 60 to apply uniform force to the inner frame 20. In this implementation, the first thermoelectric driving arm 60 includes a first electrode end 62, two first elastic arms 63, and two first connection ends 61, ends of the two first elastic arms 63 are respectively connected to the two first connection ends 61, and the other ends of the two first elastic arms 63 are both connected to the first electrode end 62.

In an implementation, the first driver module further includes the first electrode 80, the first electrode 80 is disposed on the outer frame 10, and the first electrode 80 is electrically connected to the first thermoelectric driving arm 60. In the implementation, the first electrode 80 is electrically connected to the first electrode end 62, the outer frame 10 may be designed as a circuit board, and the first electrode 80 is connected to the first electrode end 62 by using cables 83 and 84 on the circuit board.

In the implementation, a center of the first electrode end 62 is located on an extension line of the first rotation axis A1. The first electrode 80 includes a positive electrode 81 and a negative electrode 82, and the first thermoelectric driving arm 60 is connected in series between the positive electrode 81 and the negative electrode 82, to form a loop. The first electrode 80 applies a voltage or a current to the first thermoelectric driving arm 60, so that the first elastic arm 63 thermally deforms, and an end of the first elastic arm 63 that is connected to the first connection end 61 moves in the direction Z. In the implementation, a material of the first elastic arm 63 includes a multilayer metal film and a dielectric film, includes two materials that are used to generate displacement and that have different thermal expansion coefficients, for example, Cu and SiO2 (or Al and SiO2), and also includes a heating resistor layer used to generate temperature, for example, W, Ti, Pt, or polycrystalline silicon. Two ends of the heating resistor layer are respectively electrically connected to the positive electrode 81 and the negative electrode 82. When power is injected into the first electrode 80, heat is generated on the heating resistor layer to cause a temperature change. Because the two materials having the different thermal expansion coefficients exist on the first elastic arm 63, an expansion difference between the two materials changes, causing a change in a deformation of the first elastic arm 63. Consequently, the first connection end 61 displaces.

The first electrode end 62 includes two terminals respectively electrically connected to the positive electrode 81 and the negative electrode 82. When there are one first elastic arm 63 and one first connection end 61, the first elastic arm 63 continuously extends between the two terminals of the first electrode end 62, and the first connection end 61 is located at a midpoint of the first elastic arm 63. When there are two first elastic arms 63 and two first connection ends 61, one of the first elastic arms 63 is connected between one of the terminals and one of the first connection ends 61, and the other first elastic arm 63 is connected between the other terminal and the other first connection end 61.

The second driver module includes a second thermoelectric driving arm 70, the second thermoelectric driving arm 70 is connected between the inner frame 20 and the lens 30, an end of the second thermoelectric driving arm 70 that is connected to the inner frame 20 may be a second electrode end 72, and a center of the second electrode end 72 is located on an extension line of the second rotation axis A2. In an implementation, the second thermoelectric driving arm 70 includes the second electrode end 72, a second connection end 71, and a second elastic arm 73 connected between the second electrode end 72 and the second connection end 71, the second electrode end 72 is connected to the inner frame 20, and the second connection end 71 is connected to the lens 30. An architecture of the second driver module may be the same as that of the first driver module, though, in an implementation, the positions each are disposed in may be different. The second driver module is disposed between the inner frame 20 and the lens 30.

In an implementation, the second driver module further includes a second electrode 90, the second electrode 90 is disposed on the outer frame 10, and the second electrode 90 is electrically connected to the second thermoelectric driving arm 70. In the implementation, the second electrode 90 is electrically connected to the second electrode end 72. The second electrode 90 also includes a positive electrode 91 and a negative electrode 92, and the second electrode end 72 also includes two terminals. Respectively by using leads, the positive electrode 91 of the second electrode 90 is electrically connected to one terminal of the second electrode end 72, and the negative electrode 92 of the second electrode 90 is electrically connected to the other terminal of the second electrode end 72.

In an implementation, the second electrode end 72 and one of the second hinges 50 are respectively disposed on two sides of the inner frame 20 oppositely, that is, the second electrode end 72 is located on an extension line of the second hinge 50. In other words, the second hinge 50 is located on the second rotation axis A2. The second electrode 90 is electrically connected to the second thermoelectric driving arm 70 by using leads 93 and 94, and the leads 93 and 94 extend from the outer frame 10 to one of the second hinges 50, and extend to the second thermoelectric driving arm 70 along the second hinge 50.

In an implementation, an end of the second thermoelectric driving arm 70 that is connected to the lens 30 is the second connection end 71, and the center of the second connection end 71 is located on the second rotation axis A2, so that more uniform force can be applied to the lens 30.

In an implementation, as shown in FIG. 3, there are at least two second connection ends 71, and the at least two second connection ends 71 are symmetrically distributed by using the second rotation axis A2 as a center, so that a center of the second connection ends 71 is located on the second rotation axis A1. Correspondingly, there are at least two second elastic arms 73, and the at least two second elastic arms 73 are respectively connected between the at least two second connection ends 71 and the second electrode end 72. In this way, the second driver module can apply uniform force to the lens 30.

In the implementation, the first electrode end 62 is connected to a surface of the outer frame 10, and the first connection end 61 is connected to a surface of the inner frame 20. Because a thermoelectric driving arm is additionally made on a surface of a silicon material (the inner frame 20 and the lens 30 belong to a base structure) by using a semiconductor technology, the first connection end 61 is located on the surface of the inner frame 20. Likewise, the second electrode end 72 is connected to a surface of the inner frame 20, and the second connection end 71 is connected to a surface of the lens 30.

An embodiment provides a micromirror array chip, including a plurality of micromirror structures distributed in arrays. In the embodiment, outer frames 10 of all the micromirror structures are interconnected as a whole, a plurality of accommodation holes distributed in arrays may be disposed on a same base board, and one inner frame 20 and one lens 30 are disposed in each accommodation hole.

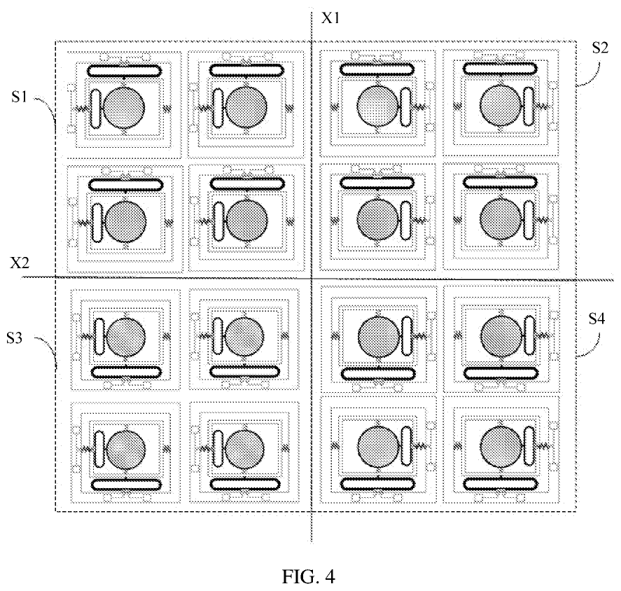

In an implementation, the micromirror array chip is divided into a plurality of areas distributed in arrays, the plurality of areas distributed in arrays include a first area and a second area that are disposed adjacent to each other, a distribution direction of the micromirror structure in the first area is mirror-symmetric to a distribution direction of the micromirror structure in the second area. Each area may include a plurality of micromirror structures distributed in an array. Referring to FIG. 4, the micromirror array chip is divided into four areas S1, S2, S3, and S4. Areas adjacent to the area S1 are the area S2 and the area S3. A distribution direction of the micromirror structure in the area S1 is mirror-symmetric to a distribution direction of the micromirror structure in the area S2 by using a first boundary line X1 as a center, and the first boundary line X1 is located between the areas S1 and S2. The distribution direction of the micromirror structure in the area Si is mirror-symmetric to a distribution direction of the micromirror structure in the area S3 by using a second boundary line X2 as a center, and the second boundary line X2 is located between the areas S1 and S3. The first boundary line X1 is perpendicular to the second boundary line X2. Micromirror structures in each of the areas S1, S2, S3, and S4 are distributed in a 2×2 array.

The micromirror array chip may be divided into more areas, and is not limited to the four areas S1, S2, S3, and S4, and the micromirror structures in each area may be alternatively distributed in another array layout, for example, distributed in a 3×3 array, or distributed in a 4×4 array.

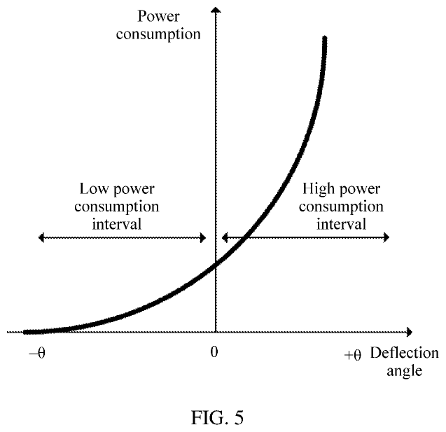

Referring to FIG. 5, it can be seen from a diagram of a relationship between a deflection angle and power consumption of a lens that there is an area with low power consumption for the deflection angle of the lens. In the implementation shown in FIG. 4, deflection angles of lenses of micromirror structures in the four areas S1, S2, S3, and S4 all need to be in a low power consumption state. Therefore, in this embodiment, a micromirror array chip layout with low power consumption can be implemented.

The foregoing descriptions are merely implementations of the present invention, but are not intended to limit the protection scope of the present invention. Any variation or replacement readily figured out by a person skilled in the art within the technical scope disclosed in the present invention shall fall within the protection scope of the present invention.

What is claimed is:

1. A micromirror structure, comprising an outer frame, an inner frame, a lens, a pair of first hinges, a pair of second hinges, a first driver module, and a second driver module, wherein:
the pair of first hinges is respectively located at two opposite ends of the lens, the pair of first hinges is connected between the lens and an inner wall of the inner frame, and a connection line of the pair of first hinges forms a first rotation axis;
the pair of second hinges is respectively located at two opposite ends of the inner frame, the pair of second hinges is connected between an outer wall of the inner frame and an inner wall of the outer frame, a connection line of the pair of second hinges forms a second rotation axis, and the first rotation axis is perpendicular to the second rotation axis;
the first driver module is connected to the inner frame, and configured to drive the inner frame, together with the lens, to rotate by using the second rotation axis as a center; and
the second driver module is connected to the lens, and configured to drive the lens to rotate by using the first rotation axis as a center.

2. The micromirror structure according to claim 1, wherein the pair of first hinges implements a rigid connection between the lens and the inner frame in a direction of the first rotation axis.

3. The micromirror structure according to claim 2, wherein the pair of second hinges implements a rigid connection between the inner frame and the outer frame in a direction of the second rotation axis.

4. The micromirror structure according to claim 1, wherein the first driver module comprises a first thermoelectric driving arm, the first thermoelectric driving arm is connected between the outer frame and the inner frame, wherein the first thermoelectric driving arm has one or more first connection ends that are connected to the inner frame, and a center position of the one or more first connection ends is located on the first rotation axis.

5. The micromirror structure according to claim 4, wherein there is one first connection end, and the first connection end is located on the first rotation axis.

6. The micromirror structure according to claim 4, wherein there are at least two first connection ends, and the at least two first connection ends are symmetrically distributed by using the first rotation axis as a center, so that a center of the first connection ends is located on the first rotation axis.

7. The micromirror structure according to claim 4, wherein the first driver module further comprises a first electrode, the first electrode is disposed on the outer frame, and the first electrode is electrically connected to the first thermoelectric driving arm.

8. The micromirror structure according to claim 7, wherein the first thermoelectric driving arm further comprises a first electrode end and a first elastic arm, the first electrode end is electrically connected to the first electrode, the first elastic arm is connected between the first electrode end and the first connection end, and a center of the first electrode end is located on an extension line of the first rotation axis.

9. The micromirror structure according to claim 4, wherein the second driver module comprises a second thermoelectric driving arm, the second thermoelectric driving arm is connected between the inner frame and the lens, wherein the second thermoelectric driving arm has a second electrode end that is connected to the inner frame, and a center of the second electrode end is located on an extension line of the second rotation axis.

10. The micromirror structure according to claim 9, wherein the second driver module further comprises a second electrode, the second electrode is disposed on the outer frame, and the second electrode is electrically connected to the second electrode end.

11. The micromirror structure according to claim 10, wherein the second electrode is electrically connected to the second electrode end by using leads, and the leads extend from the outer frame to one of the second hinges, and extend to the second electrode end along the second hinge.

12. The micromirror structure according to claim 8, wherein the second thermoelectric driving arm has one or more second connection ends that are connected to the lens, and a center position of the one or more second connection ends is located on the second rotation axis.

13. The micromirror structure according to claim 12, wherein there are at least two second connection ends, and the at least two second connection ends are symmetrically distributed by using the second rotation axis as a center, so that a center of the second connection ends is located on the second rotation axis.

14. The micromirror structure according to claim 13, wherein the second thermoelectric driving arm comprises at least two second elastic arms, ends of all the second elastic arms are all connected to the second electrode end, and the other ends of the at least two second elastic arms are connected to the at least two second connection ends in a one-to-one correspondence manner.

15. The micromirror structure according to claim 1, wherein the inner frame is of an axisymmetrical structure, and both the first rotation axis and the second rotation axis form symmetry axes of the inner frame.

16. A micromirror array chip, comprising a plurality of micromirror structures, distributed in arrays, wherein each micromirror structure comprises:
an outer frame, an inner frame, a lens, a pair of first hinges, a pair of second hinges, a first driver module, and a second driver module, wherein:
the pair of first hinges is respectively located at two opposite ends of the lens, the pair of first hinges is connected between the lens and an inner wall of the inner frame, and a connection line of the pair of first hinges forms a first rotation axis;
the pair of second hinges is respectively located at two opposite ends of the inner frame, the pair of second hinges is connected between an outer wall of the inner frame and an inner wall of the outer frame, a connection line of the pair of second hinges forms a second rotation axis, and the first rotation axis is perpendicular to the second rotation axis;
the first driver module is connected to the inner frame, and configured to drive the inner frame, together with the lens, to rotate by using the second rotation axis as a center; and
the second driver module is connected to the lens, and configured to drive the lens to rotate by using the first rotation axis as a center.

17. The micromirror array chip according to claim 16, wherein the micromirror array chip comprises a plurality of areas distributed in arrays, the plurality of areas distributed in arrays comprise a first area and a second area that are disposed adjacent to each other, a distribution direction of the micromirror structure in the first area is mirror-symmetric to a distribution direction of the micromirror structure in the second area.
